(19) United States
(12) Patent Application Publication
(10) Pub. No.: US 2013/0192924 A1
(43) Pub. Date: Aug. 1, 2013

(54) DEVICE FOR HOLDING ITEMS/TOOLS ON LADDER

(71) Applicant: Mihai Paun, Olmstead, OH (US)

(72) Inventor: Mihai Paun, Olmstead, OH (US)

(21) Appl. No.: 13/359,208

(22) Filed: Jan. 26, 2012

(51) Int. Cl. E06C 7/14

(52) U.S. Cl. 182/129; 248/210

(57) ABSTRACT

A support is mounted to a hollow end of at least one rung of an associated ladder. The support includes a body having a platform surface and a mounting member extending upwardly from the body. The mounting member is dimensioned for receipt in the hollow end of the rung. This arrangement provides a low center of gravity for the platform surface. The body includes openings, arms, shoulders, etc. for receiving various items such as paint brushes, scrapers, tools, cans, etc. A recess is received around a perimeter portion of the leg to enhance stability of the support when mounted to the ladder. The support is preferably molded from a plastic or other electrically non-conductive, non-corrosive material.

### BACKGROUND

The present disclosure relates to a support or support device. The support finds particular application and is exemplified in a preferred embodiment for use in the construction or home improvement environment, and will be described with particular reference thereto. More particularly, the support device is configured for use with a ladder and holds various items or tools on the support in a manner that is secure, stable, and convenient for the construction worker/homeowner. However, it is to be appreciated that the present exemplary embodiment is also amenable to other like applications.

Ladders, including extendable or extension ladders, have first and second legs disposed in parallel relation and interconnected by rungs that serve as steps. In many ladders, the legs and/or rungs are formed of a lightweight material such as reinforced fiberglass, composite materials, or aluminum although these materials of construction are not deemed to be exhaustive or limiting. It is typical, for example, for each leg of the ladder to have a profile that is generally U-shaped in cross-section. Such a U-shaped profile provides desired rigidity and strength, and with respect to extension ladders, the second ladder section slides relative to the first ladder section to provide a wide array of extended lengths of the ladder in a manner well known in the art.

The rungs of the ladder are often hollow construction and each end of a rung is received through a respective opening formed in one of the legs. In cross-section, each rung has an irregular profile, described herein as a generally oval profile that has a generally planar region along one of the elongated surfaces of the oval shape to provide a step surface. Moreover, this generally planar step surface is slightly tilted or angled from perpendicular relative to a longitudinal axis defined by each leg. This step surface angle is desirable since the ladder is typically oriented at an angle from true vertical when leaning against a support structure so that a base of each leg is spaced outwardly from the structure that supports the upper ends of the legs, i.e., the ladder leans at an angle against the support structure. When leaning against the structure at a slight angle, the generally planar portion of each step surface is then oriented at a substantially horizontal position.

Ladders are used for a wide variety of purposes such as construction, odd-jobs, painting, stringing lights, roofing, etc. Again, this list is not intended to be exhaustive. These various jobs often require the construction worker or homeowner to have access to various items, tools, scrapers, paintbrushes, paint cans, etc. Further, these items must be supported in a manner that can be altered (located at various positions on the ladder), stable, generally universal (used with a variety of ladders), and convenient. It would also be preferable if the support were easily manufactured, made from a minimum number of components, capable of holding a wide variety of items, and preferably formed of a material that is electrically non-conductive, durable, waterproof, and non-corrosive.

Consequently, a need exists for a support that holds items or tools on a ladder and that satisfies at least one or more of the identified needs.

### BRIEF DESCRIPTION

A support is adapted for mounting on an associated ladder that includes at least one rung extending between the first and second legs and the rung has a hollow end. The support has a body with a mounting member extending therefrom where the mounting member is dimensioned for receipt in the hollow end of the associated rung.

The support body has at least one of an opening for receipt of an associated tool, a platform surface having at least a partial rim for receiving an associated can body end, or an arm for receiving a handle of an associated can body or tool.

The mounting member includes radially extending arms projecting from spaced, perimeter locations for engaging an inner surface of the hollow end of the associated rung.

A recess is formed in the support and configured to engage at least a portion of a perimeter of a leg of the associated ladder.

In a preferred arrangement, the recess includes first and second facing surfaces joined by an interconnecting surface forming a U-shaped recess where the surfaces are dimensioned for abutting engagement with the leg perimeter portion of the associated ladder.

The U-shaped recess extends from the platform surface at an angle.

In one embodiment, the body is a one-piece, molded polymer construction, i.e., a static structure without any moving components.

The mounting arm is preferably a horizontal first portion dimensioned for receipt in the hollow end of the rung, and the platform surface is located below the mounting arm.

A first support arm extends from the body and is dimensioned for receiving a wire handle of an associated container such as a can of paint, and a second arm may be provided adjacent the first arm for holding an associated paint brush in suspended relation over an open end of the associated paint can.

The platform surface may include spaced, first and second shoulders dimensioned to abut perimeter locations of a container body therebetween.

A primary benefit is the provision of a support that is easy to manufacture.

Another advantage resides in the ease with which the support can be mounted to the associated ladder, including the ability to alter the mounting location of the support.

Still another benefit resides in the stability provided by locating a center of gravity of the support below its mounting location.

Yet another advantage is associated with the abutting engagement over at least a portion of one of the legs of the associated ladder.

A further advantage is found in the non-corrosive, electrically non-conductive, durable, waterproof material from which the support is constructed.

Still other benefits and advantages will become apparent to those skilled in the art upon reading and understanding the following detailed description.

### BRIEF DESCRIPTION OF THE DRAWINGS

FIG. 1 is a perspective view of a support mounted on a ladder and holding various items.

FIG. 2 is another perspective view of the support mounted on the ladder of FIG. 1.

FIG. 3 is an elevational view of the support on the ladder of FIG. 1.

FIG. 4 is a view taken generally from the right-hand side of FIG. 3.

FIG. 5 is a perspective view of the support separate from the ladder and without any tools or items.

FIG. 6 is a perspective view from the front and right-hand side of FIG. 5.

FIG. 7 is a front elevational view of the support.

FIG. 8 is a top plan view of the support.

FIG. 9 is a bottom plan view of the support.

FIG. 10 is a view taken generally from the left-hand side of FIG. 7.

FIG. 11 is a view taken generally from the right-hand side of FIG. 7.

### DETAILED DESCRIPTION

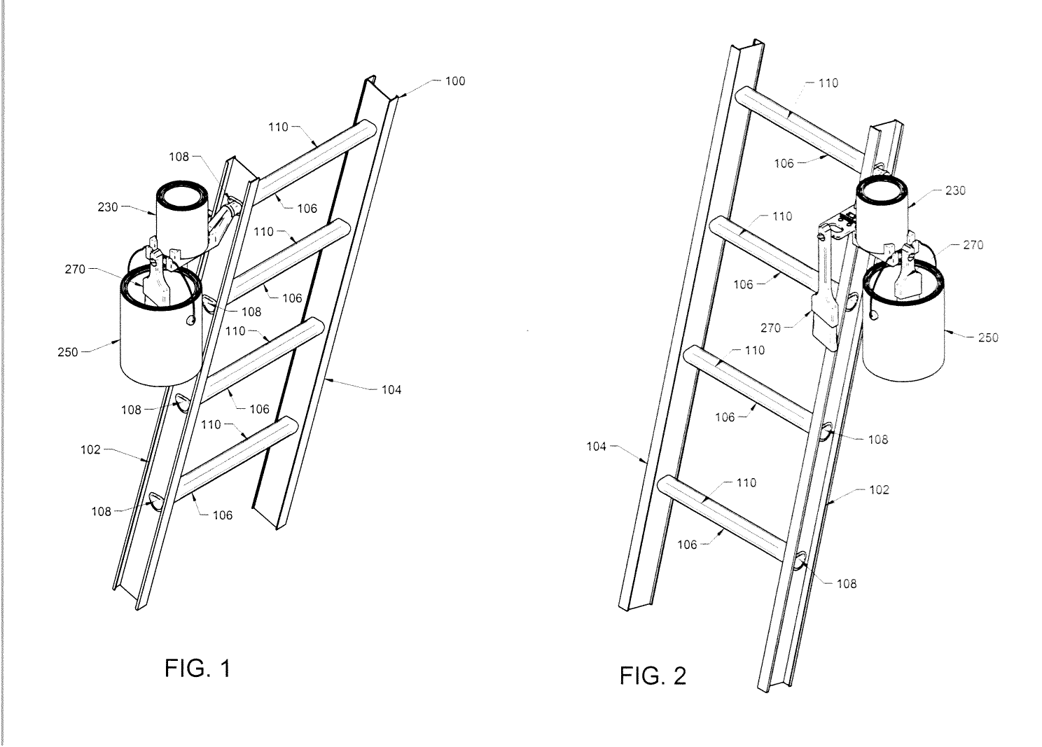

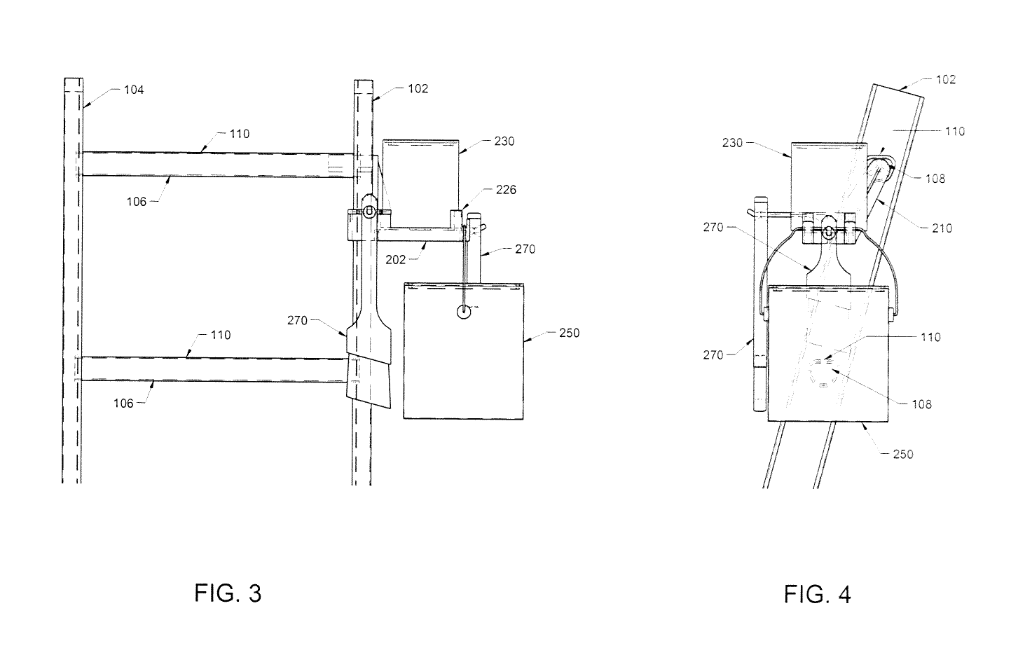

FIGS. 1-4 show a ladder or ladder section 100 (such as in an extension ladder or step ladder) having a first leg 102 and a second leg 104 disposed in generally parallel relation with one another. Each leg preferably has a generally U-shaped cross-sectional conformation, although other leg conformations are not outside the scope of the present disclosure. Extending between the first and second legs 102, 104 are a series of rungs 106 having opposite ends mounted to a respective leg. As is common, at least a portion of the rungs 106 is hollow and typically the entire rung is a hollow structure, and as shown in FIGS. 1-4 the rungs preferably have at least one hollow end 108. As noted above, this is a common construction used in lightweight ladders 100. The hollow ends 108, and also the remainder of the cross-sections of each of the rungs, has a generally irregular or oval shaped cross-section (FIG. 4) in which at least an upper portion of each rung 106 is substantially planar so that the outer surface of the rung forms a substantially planar step surface 110. As perhaps best evident in FIG. 4, the step surface 110 is not perpendicular to a longitudinal axis defined by each leg 102. 104, but instead the step surface is slightly angled relative to the longitudinal extent of the legs. In this way, when the ladder 100 leans against a support structure (not shown), the step surfaces 110 are disposed in a substantially horizontal position.

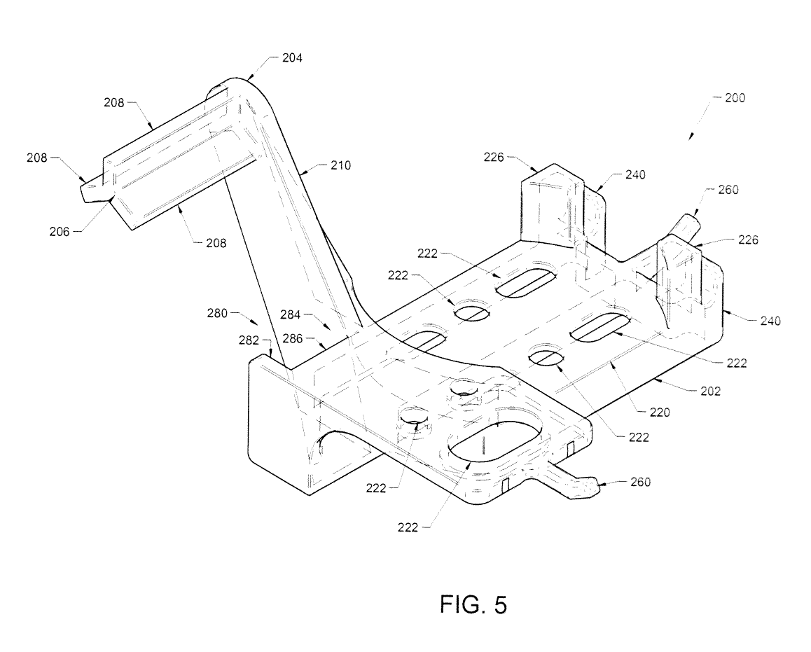

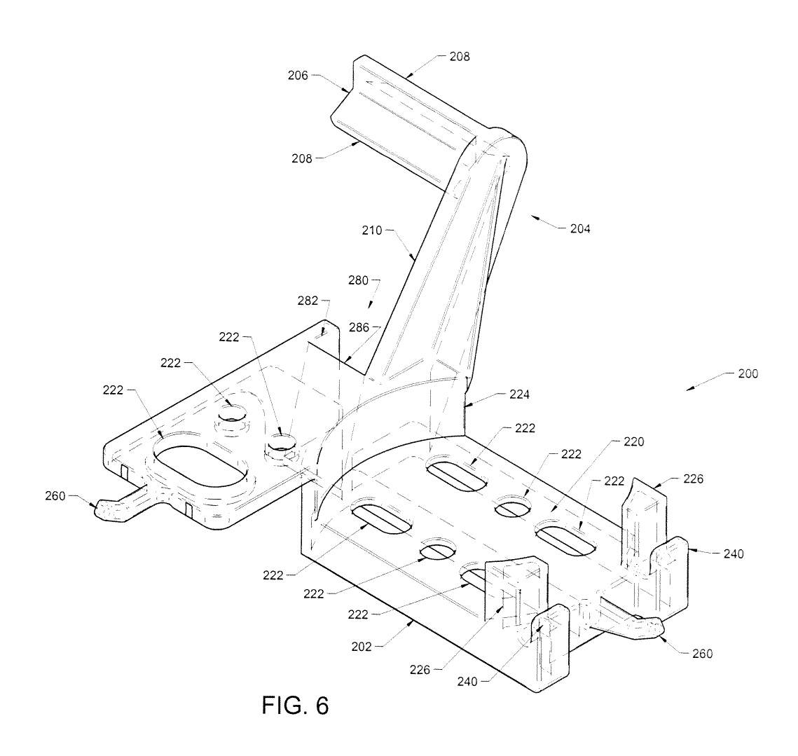

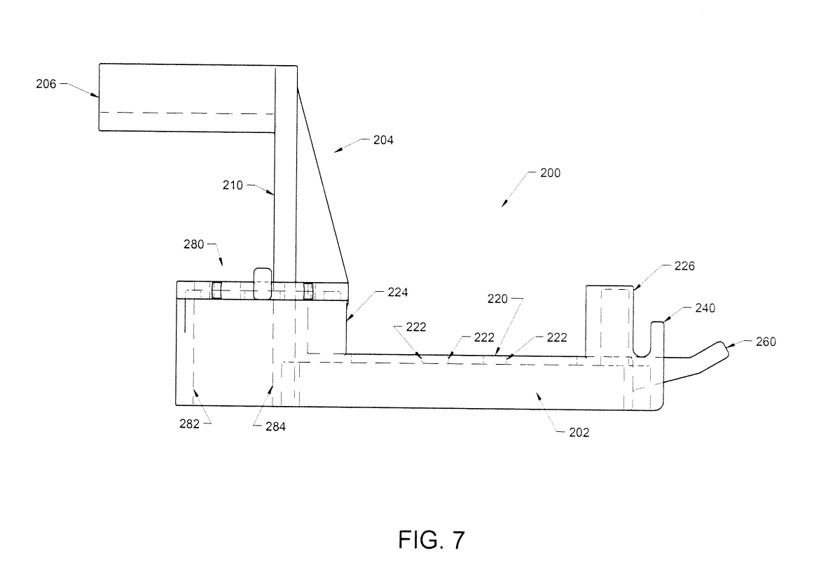

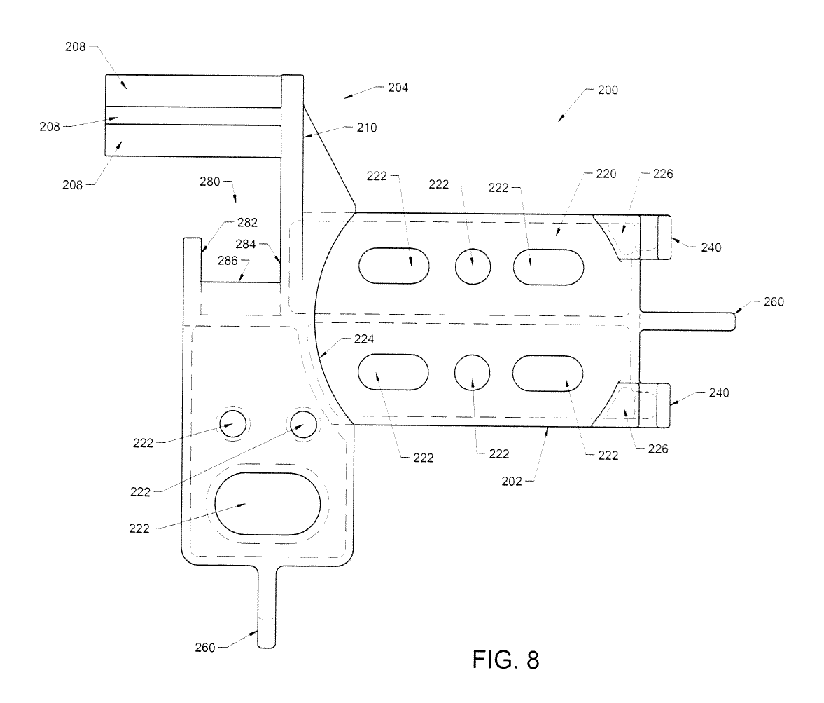

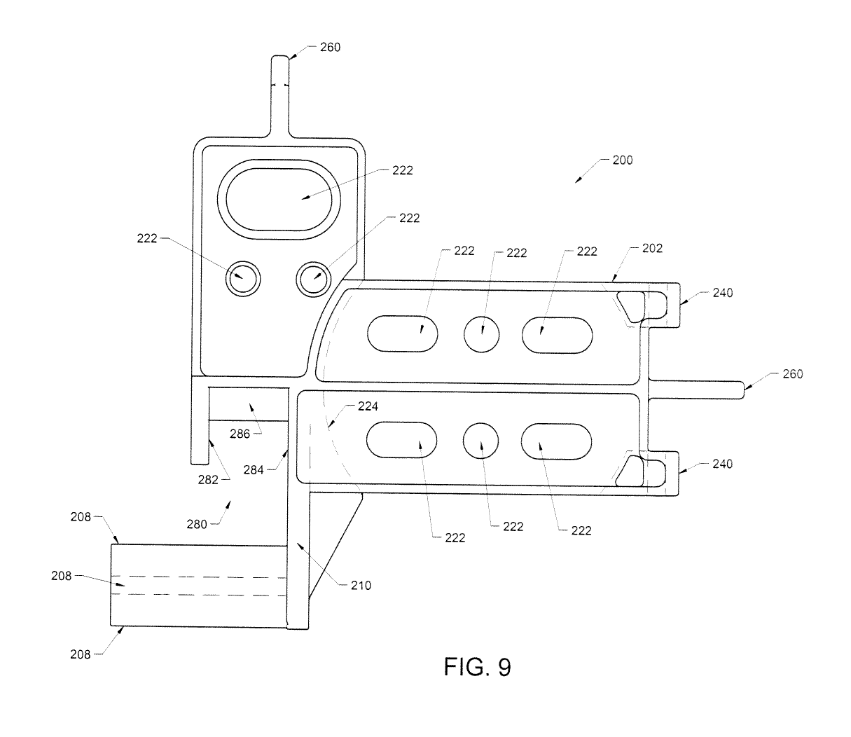

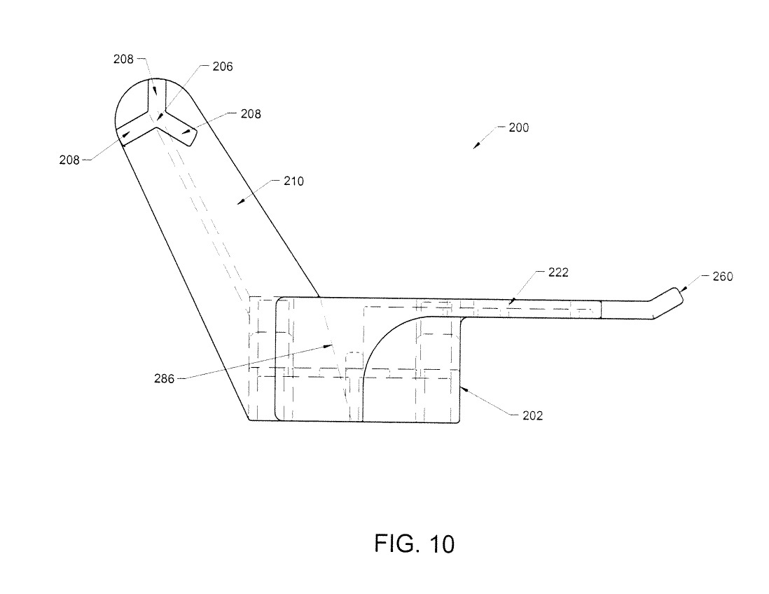

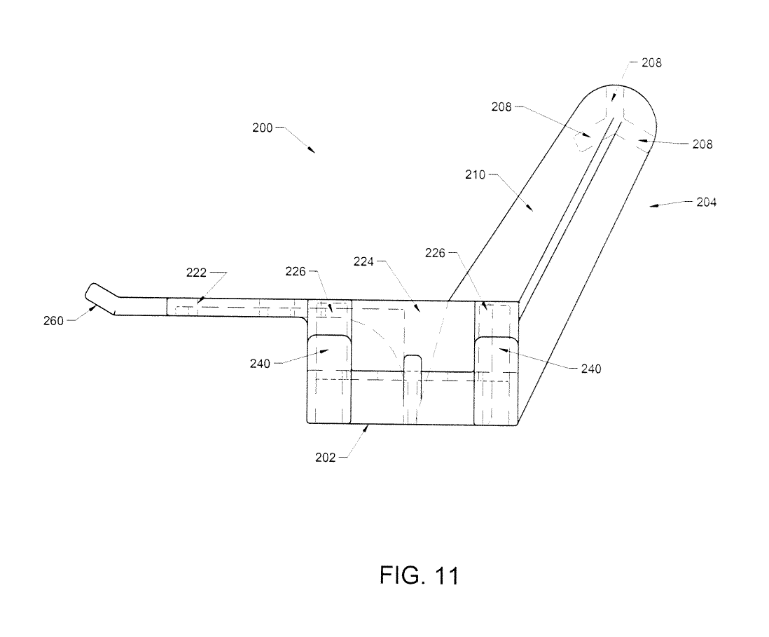

A support or support device 200 (illustrated in mounted relation in FIGS. 1-4, and by itself in FIGS. 5-11) advantageously uses the hollow end 108 of the rung in order to mount or secure the support to the associated ladder 100. The support 200 includes a body 202. A mounting arm 204 extends at an angle from body 202 and includes a first or horizontal portion 206 that is dimensioned for receipt in the hollow end 108 of one of the ladder rungs 106. Because the hollow end 108 of the rung is irregularly shaped, and may adopt a slightly different conformation from one ladder manufacturer to another, the first portion 206 of the mounting arm preferably includes radially extending arms or projections 208, shown here as a tri-lobed configuration, that is therefore generally compatible with an array of hollow end configurations. One skilled in the art will appreciate that a greater or lesser number of arms 208 may be used. In addition, each of the arms is generally equi-spaced from the other arms and extends radially outward approximately the same dimension from a central portion of the mounting arm 206. The arms are arranged and spaced so that one or more or the arms locks or abuts against the inner surface of the hollow rung and prevents slippage or rotation of the arm when received in the hollow end of the rung. Preferably, the arm(s) abuttingly engage the irregular shaped opening along a portion where the substantially planar portion of the opening merges into the remainder of the irregular shaped opening. Of course, the spacing, dimensioning, and configuration of one or more of the arms 208 may be varied without departing from the scope and intent of the present disclosure.

A second portion 210 of the mounting arm 204 interconnects the first portion 206 with the body 202. Preferably, the second portion 210 extends at an angle such that a platform surface 220 is positioned in a substantially horizontal plane when the first portion 206 of the mounting arm is in the hollow end 108 of the rung. The platform surface 220 forms a substantial portion of the body 202 and includes a number of different mounting means, such as different shaped openings 222 at spaced locations, or shoulders 224, 226 extending outwardly from the platform surface 220. In the preferred arrangement, shoulders 224, 226 extend upwardly from the platform surface a limited dimension and are spaced apart so that inner surfaces of the shoulders are adapted to receive an end of a container or can 230 (shown in FIGS. 1-4 as a small paint can 230). The shoulders 224, 226 are located to abut spaced perimeter locations of the paint can end. The inner surfaces are shown as having a curved edge to receive a container that is a conventional, generally cylindrical can, although one skilled in the art will appreciate that the shoulders may adopt a different conformation to support a different shaped container, for example, without departing from the scope and intent of the present disclosure.

Still other mounting means are provided on the platform surface such as spaced arm(s) 240 that are configured to support an item, for example, the wire-shaped handle of a conventional container 250 (shown here as a one gallon paint can). Still another arm(s) 260 is (are) provided and dimensioned for extending through an opening in a tool handle such as paint brush 270. One of the arms 260 is preferably located, for example, so that a brush 270 can be suspended over the open can 250 (FIGS. 1-4). Of course, the paint brush is just one example of a variety of items or tools that can be supported by the mounting arm.

Another feature of the support 200 is the provision of a recess 280 formed in the body by first and second facing surfaces 282, 284 joined by interconnecting surface 286. Together, the surfaces 282, 284, 286 define the generally U-shaped recess 280 that is dimensioned and configured to wrap and abuttingly engage at least a portion of a perimeter of a leg (e.g., first leg 102 or second leg 104) of the ladder 100. More specifically, the interconnecting surface 286 preferably extends at an angle that generally matches the expected angular orientation of the ladder when the ladder is generally supported upright against a structure. FIGS. 1-4 illustrate the support received on the right-hand leg of the ladder, although it is understood that the support 200 could be configured for receipt on the left-hand leg (e.g., to accommodate a left-handed user). As noted above, mounting arm 204, and particularly the horizontal portion 206, is received in the hollow end 108 of one of the rungs. The angled portion 210 of the mounting arm extends between the rung and the platform surface 220 and is generally designed so that the platform surface adopts a generally horizontal, planar orientation. The recess 280 adds further stability when mounting the support 200 so that the support is stably connected to the ladder. The first portion 206 of the mounting arm is received in the open end of the rung and the remainder of the support body is rotated downwardly so that the recess 280 is received over the leg of the ladder and abuttingly engages the leg perimeter. Once mounted in this manner, and where the platform surface is substantially horizontal, substantial weight can be carried by the support. For example, a gallon can of paint, an additional container, scrapers, paintbrushes, screwdrivers, pry members, etc. can be carried by the support 200 and the weight/forces effectively transferred to the leg of the ladder.

One skilled in the art will also appreciate that one or more of the above-described features may be used individually, together, or in various combinations. For example, the angled mounting arm 204 is particularly useful in assuring that the weight of items carried by the support is below the mounting location of the support to the ladder and thus resulting in a low center of gravity. Another feature relates to the recess that abuts along at least a portion of the leg perimeter of the ladder. In the embodiment shown and described herein, the generally U-shaped recess encompasses a portion of the leg and adds stability to the support when mounted to the ladder. Moreover, in conjunction with the ability to easily mount the support to a hollow end of a rung, the platform surface is situated to one side of the ladder where items can be conveniently stored/accessed by the contractor or homeowner.

Further, by manufacturing the support as a one-piece component that has no moving parts, the support 200 can be easily molded from plastic or another electrically inert or non-conductive material. Further, the molded support will not corrode, is lightweight and waterproof, can be inexpensively manufactured, and used in a wide array of different ladders. The mounting arm, and particularly the first, horizontal portion received in the open end of the rung of the ladder is adapted to a wide array of irregular conformations of the open end of the rung.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

I claim:

1. A support adapted for mounting on an associated ladder that includes at least one rung extending between the first and second legs, the rung having a hollow end, the support comprising:
a body having at least one of (i) an opening for receipt of an associated tool, (ii) a platform surface having at least a partial rim for receiving an associated can body end, or (iii) an arm for receiving a handle of an associated can body or tool; and
a mounting member extending from the body and dimensioned for receipt in the hollow end of the at least one associated rung.

2. The support of claim 1 wherein the mounting member is offset above the body.

3. The support of claim 1 wherein the mounting member includes radially extending arms projecting from perimeter spaced locations for engaging an inner surface of the hollow end of the associated rung.

4. The support of claim 1 further comprising a recess configured to engage at least a portion of a perimeter of a leg of the associated ladder.

5. The support of claim 4 wherein the recess includes first and second facing surfaces joined by an interconnecting surface, the facing and interconnecting surfaces dimensioned for abutting engagement with the leg perimeter portion of the associated ladder.

6. The support of claim 4 wherein the recess extends along a first axis that is substantially perpendicular to the mounting number.

7. The support of claim 1 wherein the body is a molded polymer construction.

8. The support of claim 1 wherein the body is a one-piece construction.

9. The support of claim 1 wherein the body is a static structure without any moving components.

10. A support for accessing items on an associated ladder where the ladder includes first and second legs disposed in spaced relation by at least one rung extending between the legs, the support comprising:
a body having at least one of (i) an opening dimensioned for receipt of an associated tool, or (ii) platform surface having at least a partial rim for receiving an associated can body end; and
a recess formed in the body including first and second facing surfaces joined by an interconnecting surface, the facing and interconnecting surfaces dimensioned for abutting engagement with at least a portion of a perimeter of the first leg of an associated ladder.

11. The support of claim 10 further comprising a mounting arm extending from the body and dimensioned for receipt in a hollow end of the at least one rung.

12. The support of claim 11 wherein the mounting arm has a first horizontal portion dimensioned for receipt in the hollow end of the rung, a second portion extending downwardly from the first horizontal portion and joined to the platform surface so that the platform surface is located below the mounting arm when the support is mounted to the associated ladder.

13. The support of claim 11 wherein the mounting arm includes a tri-lobed configuration adapted for receipt in the hollow end of the associated rung.

14. The support of claim 10 further comprising a first arm extending from the body dimensioned for receiving a wire handle of an associated paint can.

15. The support of claim 14 further comprising a second arm extending from the body adjacent the first arm for receiving an associated paint brush in hanging relation over an open end of the associated paint can.

16. A support for accessing items on an associated ladder where the ladder includes first and second legs disposed in spaced relation by at least one rung extending between the legs, the support comprising:
a body having at least one of (i) an opening dimensioned for receipt of an associated tool, (ii) platform surface having at least a partial rim for receiving an associated can body end, or (iii) an arm for receiving a handle of an associated can body or tool; and
a mounting member extending above the body for engagement with the associated ladder such that a center of gravity of the support is located below the mounting location on the associated ladder.

17. The support of claim 16 wherein the platform surface is oriented in a substantially horizontal plane below the mounting member.

18. The support of claim 16 wherein the platform surface includes spaced, first and second shoulders extending above an upper surface of the platform surface, the spacing between the shoulders dimensioned to abut perimeter locations of a paint can body therebetween.

19. The support of claim 16 further comprising a substantially U-shaped recess formed in the body including first and second facing surfaces joined by an interconnecting surface, the interconnecting surface disposed at an angle between 0 and 90 degrees from the generally horizontally extending platform surface.

20. The support of claim 19 wherein the mounting member and the substantially U-shaped recess are joined by an arm extending at the same angle as the interconnecting surface.
